(19) United States
(12) Patent Application Publication
(10) Pub. No.: US 2023/0109750 A1
(43) Pub. Date: Apr. 13, 2023

(54) Method for manufacturing a fire-resistant and/or fire-retardant cable

(71) Applicant: NEXANS, Courbevoie (FR)

(72) Inventors: Thierry AUVRAY, LYON (FR); Franck GYPPAZ, LYON (FR)

(21) Appl. No.: 17/913,753

(22) PCT Filed: Apr. 2, 2021
(86) PCT No.: PCT/FR2021/050588

§ 371 Date: Sep. 22, 2022

(30) Foreign Application Priority Data
Apr. 6, 2020 (FR) 2003415

(51) Int. Cl. H01B 7/295; H01B 13/14; H01B 13/26; H01B 13/22; B29C 48/154

(52) U.S. Cl. CPC H01B 7/295; H01B 13/14; H01B 13/26; H01B 13/221; B29C 48/154; B29L 2031/3462

(57) ABSTRACT

The present invention relates to a method for manufacturing a cable comprising at least one elongate electrically conductive element, at least one composite layer surrounding the elongate electrically conductive element, the composite layer comprising a non-woven fibrous material impregnated by a geopolymer material, and at least one polymer sleeve surrounding the composite layer, the method using a tube of plastic material to facilitate the extrusion of the polymer sleeve around the composite layer.

The present invention relates to a method for manufacturing a cable comprising at least one elongate electrically conductive element, at least one composite layer surrounding said elongate electrically conductive element, said composite layer comprising a nonwoven fibrous material impregnated with a geopolymer material, and at least one polymer sheath surrounding said composite layer, said method employing a plastic tube for facilitating the extrusion of said polymer sheath around the composite layer.

It applies typically but not exclusively to fire-retardant and/or fire-resistant cables intended for the transmission of power and/or the transmission of data such as, in particular halogen-free, fire-retardant and/or fire-resistant electrical and/or optical safety cables that are able to function for a given period of time under fire conditions without however propagating the fire or generating large amounts of smoke. These safety cables are in particular medium-voltage (especially from 6 to 45-60 kV) power transmission cables or low-frequency transmission cables, such as control or signaling cables.

WO 2016/092200 discloses a method for manufacturing a fire-resistant cable, comprising the following steps: a step of preparing a geopolymer composition; a step of wrapping a nonwoven fibrous material around at least one metallic conductor, a step of impregnating the metallic conductor/nonwoven fibrous material in the geopolymer composition previously prepared, a step of curing the geopolymer composition to form a composite layer comprising said nonwoven fibrous material impregnated with a geopolymer material and surrounding the metallic conductor, and a step of high-temperature extrusion of a polymer sheath around the composite layer. During the manufacture of the cable, the geopolymer composition at the surface of the nonwoven material is still liquid, and it then flows into the metallic parts of the extruder, cures, and is transformed at least partially into ceramic, resulting in the obstruction or the blockage of the extrusion head and preventing the extrusion of the polymer sheath around the composite layer.

The object of the invention is consequently that of overcoming all or some of the above-mentioned drawbacks and of providing a method for manufacturing a fire-retardant cable, said method being easy to implement, in particular readily industrializable, economic and rapid, and making it possible in particular to facilitate the step of extrusion of the polymer sheath around the geopolymer-based composite layer.

A first subject of the invention is a method for manufacturing a cable comprising at least one elongate electrically conductive element, at least one composite layer surrounding said elongate electrically conductive element, said composite layer comprising a nonwoven fibrous material impregnated with a geopolymer material, and at least one polymer sheath surrounding said composite layer, characterized in that it comprises at least the following steps:

i) passing a cable comprising at least one elongate electrically conductive element, and at least one nonwoven fibrous material impregnated with a geopolymer composition surrounding said elongate electrically conductive element, into a plastic tube, and

ii) extruding a polymer sheath using an extruder comprising at least one extruder head equipped with a die and a punch,

said method being characterized in that a portion of said plastic tube is inserted into the extruder head and is configured to prevent contact between the geopolymer composition and the punch of the extruder head.

The method of the invention is rapid, easy to implement, in particular industrially and economically, and it guarantees the production of a fire-resistant and/or fire-retardant cable having good mechanical properties, in particular in terms of flexibility and durability. Furthermore, the method of the invention makes it possible, on the one hand, to facilitate the conformation of the nonwoven fibrous material around the elongate electrically conductive element, to improve the impregnation of the nonwoven fibrous material by the geopolymer composition, and also to avoid the ceramification of the geopolymer composition within the extruder head, thus facilitating the extrusion of the polymer sheath around the geopolymer-based composite layer.

Step i)

Step i) makes it possible to place or introduce the cable comprising at least one elongate electrically conductive element and at least one nonwoven fibrous material impregnated with a geopolymer composition surrounding said elongate electrically conductive element, into a plastic tube. This step of confining said cable within said plastic tube makes it possible, on the one hand, to facilitate the conformation of the nonwoven fibrous material around the elongate electrically conductive element, and, on the other hand, to improve the impregnation of the nonwoven fibrous material by the geopolymer composition.

During step i), the plastic tube surrounds the cable, and in particular surrounds the nonwoven fibrous material impregnated with said geopolymer composition.

The tube of the invention is made of plastic in order in particular to prevent the geopolymer composition from adhering to said tube. Furthermore, since the plastic tube is a poorer thermal conductor than the metal, this makes it possible to prevent the geopolymer material from setting at the interface (i.e. to avoid the geopolymer composition drying too quickly at the interface).

The plastic tube can comprise (or consist of) a polymer material selected from:
thermostable thermoplastic polymers (i.e. stable at a temperature of greater than or equal to around 250° C.), such as polyaryletherketones (PAEKs) [e.g. polyetheretherketones (PEEKs), polyetherketoneketones (PEKKs), polyetherketones (PEKs), polyetheretherketoneketones (PEEKKs), polyetherketoneetherketoneketones (PEKEKKs)], polyetheri m ides (PEIs), polyethersulfones (PESs), polysulfones (PSs) or polyimides (PIs),
polyamides (PAs), and polyamide-imides (PAIs),
fluoropolymers such as poly(vinylidene fluoride-co-trifluoroethylene) [P(VdF-TrFE)] or poly(vinylidene fluoride-co-hexafluoropropene) [P(VdF-HFP)], polytetrafluoroethylene (PTFE), a copolymer of tetrafluoroethylene and of hexafluoropropylene (FEP), or ETFE,
polymer resins having a melting temperature greater than about 200° C., and
a mixture thereof.

The polymer material is preferably selected from polyaryletherketones, and particularly preferably is selected from PEEKs.

The polymer material thus selected has the advantage of having surface and/or physicochemical properties suitable for facilitating step i), in particular said polymer material does not exhibit any roughness, and has a high chemical inertness, and/or ease of machining.

The plastic tube is preferably a sealed tube. In particular, the plastic tube is leaktight with respect to the geopolymer composition impregnating said nonwoven fibrous material.

The plastic tube is a hollow cylinder. It is defined by an external diameter “Dext” and an internal diameter “Dint”.

Said plastic tube preferably has a thickness determined by the difference between the external diameter of the cable used in step i) and the internal diameter of the extruder head. This thickness is therefore chosen as a function of the external diameter of the cable used in step i) and of the internal diameter of the extruder head used. The thickness is defined by the difference between the external diameter of the tube “Dext” and the internal diameter of the tube “Dint” such that “Dint” is strictly greater than the external diameter of the cable used in step i) and “Dext” is strictly less than the internal diameter of the extruder head.

According to one embodiment, the plastic tube is configured such that the distance “d” between the outer surface of the nonwoven fibrous material and the inner surface of said tube is at most about 1 mm, and particularly preferably at most about 0.5 mm.

In other words, the distance “d” defines the empty radial space between the nonwoven fibrous material impregnated with the geopolymer composition and the inner surface of the tube.

By virtue of this maximum distance “d”, the conformation of the nonwoven fibrous material around the elongate electrically conductive element is maintained (i.e. the nonwoven material surrounding the elongate electrically conductive element cannot come open), and the impregnation of the nonwoven fibrous material by the geopolymer composition is facilitated. The homogeneity of the composite layer around the elongate electrically conductive element is also improved.

The distance “d” is preferably at least about 0.2 mm, and particularly preferably at least about 0.3 mm.

The method of the invention is additionally characterized in that a portion of said plastic tube is inserted into the extruder head and is configured to prevent contact between the geopolymer composition and the punch of the extruder.

Since the tube is partially disposed in the extrusion head or extruder head, and since the tube is sealed, any flow of the geopolymer composition is prevented at the punch, but also throughout the path of the impregnated cable towards the extruder head. Furthermore, this also makes it possible to ensure that the nonwoven material, in particular when it is in the form of a tape applied longitudinally, remains closed around the cable, i.e. completely surrounds the elongate electrically conductive element).

The tube has another portion which is not inserted into the extruder head.

This other portion preferably has a length of at least about 100 mm. This thus makes it possible to facilitate the exit or withdrawal of the tube from the extruder head.

Thus, during step i), the geopolymer composition is not in contact with the extruder head, and more particularly with the punch of the extruder head, or with any of the metal parts contained in the head of extruder.

Preferably, the tube is maintained in place in the extruder head by means of two rings made of metal, or of plastic as defined in the invention, which may be identical to or different from, and preferably identical to, the plastic of the tube.

Advantageously, the portion of the tube that is inserted into the extruder head comprises an end which is connected to a plastic insert configured to adapt to the punch of the extruder head.

Said plastic insert may comprise (or consist of) a polymer material as defined in the invention. The plastic of the insert may be identical to or different from, and preferably identical to, that of said tube.

The presence of the plastic insert makes it possible to prevent any contact between the geopolymer composition and the punch of the extruder head.

The plastic insert preferably has a shape similar to that of the punch and particularly preferably has a conical shape.

Step i) is preferably carried out at ambient temperature (i.e. 18-25° C.).

Step i) can be carried out manually or in an automated fashion, and preferably in an automated fashion.

When it is automated, step i) is carried out at a speed ranging from 20 to 280 m/min approximately, and preferably ranging from 50 to 150 m/min approximately.

The Nonwoven Fibrous Material

The nonwoven fibrous material preferably has a pliable and flexible structure.

The nonwoven fibrous material can be selected from cellulosic materials, materials based on synthetic organic polymers, glass fibers and a mixture thereof, and preferably from materials based on synthetic organic polymers.

The cellulosic materials can be selected from paper, in particular blotting paper; nonwoven materials made from functionalized or non-functionalized cellulose; matrices with a honeycomb and/or fibrous structure made from natural cellulose acetate fibers.

The materials based on synthetic organic polymers can be selected from polymer materials having a porous and/or fibrous matrix of polyolefin(s), in particular those selected from propylene homo- and copolymers, ethylene homo- and copolymers, high-density polyethylenes (HDPEs), aromatic polyamides (aramids), polyesters, and a mixture thereof.

According to a preferred embodiment of the invention, the nonwoven fibrous material is a polyethylene terephthalate (PET).

The nonwoven fibrous material preferably has a basis weight ranging from 50 to 120 g/cm² approximately. This thus makes it possible to obtain a composite layer that is sufficiently flexible to be able to be handled easily, and sufficiently robust to provide good fire protection.

According to a preferred embodiment of the invention, the nonwoven fibrous material represents from 2% to 95% by weight approximately, particularly preferably from 5% to 45% by weight approximately, and even more preferentially from 10% to 35% by weight approximately, relative to the total weight of the composite layer.

The nonwoven fibrous material is preferentially in the form of a tape or a strip. This thus makes it possible to facilitate step i).

The Geopolymer Composition

The geopolymer composition used in step i) is preferably a liquid geopolymer composition.

The geopolymer composition of step i) is preferably an aluminosilicate geopolymer composition.

The geopolymer composition of the invention is particularly preferably a geopolymer composition comprising water, silicon (Si), aluminum (Al), oxygen (O), and at least one element selected from potassium (K), sodium (Na), lithium (Li), cesium (Cs), and calcium (Ca), and preferably selected from potassium (K) and sodium (Na).

The geopolymer composition may in particular comprise at least a first aluminosilicate, at least a first alkali metal silicate, water, and optionally an alkaline base.

The First Aluminosilicate

The first aluminosilicate can be selected from metakaolins (i.e. calcined kaolins), fly ash, blast furnace slag, swelling clays such as bentonite, calcined clays, any type of compound comprising aluminum and silica fume, zeolites, and a mixture thereof.

Among these compounds, metakaolins are preferred, and in particular those sold by the company Imerys.

In the invention, the term “metakaolin” denotes a calcined kaolin or a dehydroxylated aluminosilicate. It is preferably obtained by dehydration of a kaolin or of a kaolinite.

The geopolymer composition may comprise from 5% to 50% by weight approximately of aluminosilicate, and preferably from 10% to 35% by weight approximately of aluminosilicate, relative to the total weight of the geopolymer composition.

The geopolymer composition may additionally comprise a second aluminosilicate different from the first aluminosilicate.

Preferably, the geopolymer composition comprises two calcined kaolins having different calcination temperatures.

According to a particularly preferred embodiment of the invention, the geopolymer composition comprises a first metakaolin chosen from kaolins calcined at a temperature T_{c1} of at least approximately 650° C., and a second metakaolin chosen from kaolins calcined at a temperature T_{c2} such that T_{c2}−T_{c1}≥100° C. approximately, at least a first alkali metal silicate, water, and optionally an alkaline base. The geopolymer composition may then have improved mechanical properties, in particular in terms of flexibility and durability, while guaranteeing good reaction properties and fire resistance.

According to one embodiment of the invention, the first metakaolin is a kaolin calcined at a temperature T_{c1} of at least about 700° C., and preferably of at least about 725° C.

According to a preferred embodiment of the invention, the first metakaolin is a kaolin calcined at a temperature T_{c1} of at most about 875° C., and preferably of at most about 825° C.

The first metakaolin may comprise at least about 20 mol %, and preferably at least about 30 mol % of aluminum oxide (Al₂O₃), relative to the total number of moles of the first metakaolin.

The first metakaolin may comprise at most about 60 mol %, and preferably at most about 50 mol % of aluminum oxide (Al₂O₃), relative to the total number of moles of the first metakaolin.

The first metakaolin may comprise at least about 35 mol %, and preferably at least about 45 mol % of silicon oxide (SiO₂), relative to the total number of moles of the first metakaolin.

The first metakaolin may comprise at most about 75 mol %, and preferably at most about 65 mol % of silicon oxide (SiO₂), relative to the total number of moles of the first metakaolin.

As examples of first metakaolin, mention may be made of the metakaolins sold by the company Imerys, in particular the one sold under the reference PoleStar® 450.

The first metakaolin can be selected from kaolins calcined at T_{c1} as defined in the invention, for at least about 1 min, preferably for at least about 10 min, particularly preferably for a period ranging from about 30 min to 8 h, and more particularly preferably for a period ranging from about 2 h to 6 h.

The second metakaolin is preferably selected from kaolins calcined at a temperature T_{c2} such that T_{c2}−T_{c1}≥150° C. approximately, particularly preferably such that T_{c2}−T_{c1}≥200° C. approximately, and more particularly preferably such that T_{c2}−T_{c1}≥250° C. approximately.

According to one embodiment of the invention, the second metakaolin is a kaolin calcined at a temperature T_{c2} of at least about 800° C., preferably of at least about 850° C., and particularly preferably of at least about 900° C.

According to a preferred embodiment of the invention, the second metakaolin is a kaolin calcined at a temperature T_{c2} of at most about 1200° C., and preferably of at most about 1150° C.

The second metakaolin may comprise at least about 20 mol %, and preferably at least about 30 mol % of aluminum oxide (Al₂O₃), relative to the total number of moles of the second metakaolin.

The second metakaolin may comprise at most about 60 mol %, and preferably at most about 50 mol % of aluminum oxide (Al₂O₃), relative to the total number of moles of the second metakaolin.

The second metakaolin may comprise at least about 35 mol %, and preferably at least about 45 mol % of silicon oxide (SiO₂), relative to the total number of moles of the second metakaolin.

The second metakaolin may comprise at most about 75 mol %, and preferably at most about 65 mol % of silicon oxide (SiO₂), relative to the total number of moles of the second metakaolin.

As examples of second metakaolin, mention may be made of the metakaolins sold by the company Imerys, in particular the one sold under the reference PoleStar® 200R.

The second metakaolin can be selected from kaolins calcined at T_{c2} as defined in the invention, for at least about 1 min, preferably for at least about 5 min, particularly preferably for a period ranging from about 10 min to 2 h, and more particularly preferably for a period ranging from about 15 min to 1 h.

The [first metakaolin/second metakaolin] mass ratio in the geopolymer composition preferably ranges from 0.1 to 2 approximately, particularly preferably from 0.5 to 1.0 approximately, and more particularly preferably is about 1.

The geopolymer composition may comprise from 5% to 50% by weight approximately, and preferably from 10% to 35% by weight approximately of first and second metakaolins, relative to the total weight of the geopolymer composition.

The first and second metakaolins can be analyzed by differential thermal analysis (DTA) [absence or presence of a crystallization point or peak], nuclear magnetic resonance (NMR) [²⁷Al NMR spectrum], and/or X-ray diffraction (XRD).

The first metakaolin preferably exhibits a crystallization peak by differential thermal analysis, particularly preferably at a temperature ranging from 900 to 1060° C., and more particularly preferably at a temperature ranging from 950 to 1010° C.

The second metakaolin preferably comprises mullite.

The First Alkali Metal Silicate

The first alkali metal silicate can be selected from sodium silicates, potassium silicates, and a mixture thereof.

The alkali metal silicates sold by Silmaco or by PQ Corporation are preferred. The first alkali metal silicate is preferably a sodium silicate.

The first alkali metal silicate may have an SiO₂/M₂O molar ratio ranging from 1.1 to 35 approximately, preferably from 1.3 to 10 approximately, and particularly preferably from 1.4 to 5 approximately, with M being a sodium or potassium atom, and preferably a sodium atom.

The geopolymer composition may comprise from 5% to 60% by weight approximately, and preferably from 10% to 50% by weight approximately of first alkali metal silicate, relative to the total weight of the geopolymer composition.

The Second Alkali Metal Silicate

The geopolymer composition may additionally comprise a second alkali metal silicate different from the first alkali metal silicate.

The second alkali metal silicate can be selected from sodium silicates, potassium silicates, and a mixture thereof. The alkali metal silicates sold by Silmaco or by PQ Corporation are preferred. The second alkali metal silicate is preferably a sodium silicate.

The first and second alkali metal silicates can respectively have SiO₂/M₂O and SiO₂/M′₂O molar ratios such that M and M′, which are identical, are selected from a sodium atom and a potassium atom, and preferably a sodium atom, and said ratios have different values, preferably values such that their difference is at least 0.3, particularly preferably such that their difference is at least 0.5, and more particularly preferably such that their difference is at least 1.0.

According to one embodiment of the invention, the geopolymer composition comprises:
a first alkali metal silicate having an SiO₂/M₂O molar ratio ranging from 1.5 to 2.6 approximately, and
a second alkali metal silicate having an SiO₂/M′₂O molar ratio of greater than 2.6, preferably ranging from 2.8 to 4.5 approximately, and particularly preferably ranging from 3.0 to 4.0 approximately, it being understood that M′ is identical to M.

The geopolymer composition may comprise from 10% to 60% by weight approximately, and preferably from 20% to 50% by weight approximately of first and second alkali metal silicates, relative to the total weight of the geopolymer composition.

The [first alkali metal silicate/second alkali metal silicate] mass ratio in the geopolymer composition preferably ranges from 0.5 to 2.5, and particularly preferably from 0.8 to 2.0.

The Alkaline Base

The alkaline base can be sodium hydroxide, or potassium hydroxide, and preferably sodium hydroxide.

The geopolymer composition may be free from alkaline base. This thus makes it possible to improve the handling of the geopolymer composition, in particular during the preparation of a cable.

Additives

The geopolymer composition may additionally comprise one or more additives selected from:
a dye,
mineral fibers, in particular selected from alumina fibers,
an additive with polymer structure, in particular selected from polyolefin fibers such as polypropylene or polyethylene fibers (e.g. high-density polyethylene or HDPE fibers), aramids, and technical glass fibers coated with silicone or with an organic polymer of polyethylene type; a styrene-butadiene (SBR) copolymer; a styrene-butadiene-ethylene (EBS) copolymer; styrene-ethylene copolymer derivatives, especially those sold by Kraton such as a styrene-ethylene-butylene-styrene (SEBS) copolymer, a styrene-butadiene-styrene (SBS) copolymer, a styrene-isoprene-styrene (SIS) copolymer, a styrene-propylene-ethylene (EPS) copolymer or a styrene-ethylene-propylene-styrene (SEPS) copolymer; an ethylene-vinyl acetate (EVA) copolymer, a polyorganosiloxane that has been crosslinked (e.g. with the aid of a peroxide); polyethylene optionally in powder form; lignosulfonates; cellulose acetate; other cellulose derivatives; a silicone oil of low viscosity (e.g. of the order of 12 500 cP); and a polyethylene oil,
a caking accelerator compound, in particular selected from aluminum sulfate, alums (e.g. aluminum-potassium double sulfate), calcium chloride, calcium sulfate, hydrated calcium sulfate, sodium aluminate, sodium carbonate, sodium chloride, sodium silicate, sodium sulfate, iron(III) chloride, and sodium lignosulfonates,
a caking retardant, especially selected from ammonium, alkali metals, alkaline earth metals, borax, lignosulfonates and in particular metal salts of calcium lignosulfonates, celluloses such as carboxymethyl hydroxyethyl cellulose, sulfoalkylated lignins such as for example sulfomethylated lignin, hydroxycarboxylic acids, copolymers of salts of 2-acrylamido methylpropanesulfonic acid and of acrylic acid or maleic acid, and saturated salts,
an inert filler, in particular selected from talc, micas, dehydrated clays, and calcium carbonate,
a starch,
a starch plasticizer, in particular selected from a metal stearate, a polyethylene glycol, an ethylene glycol, a polyol such as glycerol, sorbitol, mannitol, maltitol, xylitol or an oligomer of one of these polyols, a sucrose such as glucose or fructose, a plasticizer containing amide groups, and any type of plasticizer based on modified polysaccharide(s),
an expanded carbon-based material such as an expanded graphite.

The dye is preferably a dye liquid at ambient temperature (i.e. at 18-25° C.).

The geopolymer composition may comprise from 0.01% to 15% by weight approximately of additive(s), and preferably from 0.5% to 8% by weight approximately of additive(s), relative to the total weight of the geopolymer composition.

Step ii)

Extrusion step ii) is carried out after step i). By virtue of the presence of the plastic tube, the ceramification of the geopolymer composition within the extruder is prevented, thus facilitating the extrusion of the polymer sheath around the geopolymer-based composite layer. This also makes it possible to prevent the blockage or obstruction of the extruder as well as its deterioration.

Specifically, during the extrusion the nonwoven fibrous material is impregnated with the liquid geopolymer composition, but the low viscosity thereof leads to observation of dripping effects. Upon contact with a hot metal surface, the geopolymer is transformed into a rigid ceramic. Over time, a compact block of ceramic thus forms in the extruder head and ultimately obstructs the passage of the cable. By virtue of the plastic tube, the geopolymer composition is transported within the cable by virtue of the nonwoven fibrous material which, after a few hours, becomes a cohesive layer that provides protection against fire.

The polymer sheath of step ii) can make it possible to ensure the mechanical integrity of the cable. Reference may then be made to a protective sheath.

At the end of step ii), the cable may then comprise at least one elongate electrically conductive element, the composite layer surrounding said elongate electrically conductive element, and at least one polymer sheath surrounding said composite layer.

Step ii) is preferably carried out at a temperature ranging from 140° C. to 225° C. approximately, and particularly preferably ranging from 170° C. to 210° C. approximately.

Step ii) preferably employs a distributor configured to allow the passage, between the punch and the die of the extruder head, of at least one molten polymer material suitable for forming the polymer sheath.

Step ii) can be carried out in automated fashion.

Step ii) is carried out at a speed ranging from 20 to 280 m/min approximately, and preferably ranging from 50 to 150 m/min approximately.

The polymer sheath is preferably the outermost layer of the cable.

The polymer sheath is preferably an electrically insulating layer.

The polymer sheath is preferably made of a halogen-free material. It may be made conventionally from flame-propagation-retardant or flame-propagation-resistant materials. In particular, if the latter do not contain any halogen, reference is made to sheathing of HFFR (halogen-free flame retardant) type.

The polymer sheath may comprise at least one organic or inorganic polymer.

The choice of organic or inorganic polymer is not limiting and a person skilled in the art is highly familiar with them.

According to a preferred embodiment of the invention, the organic or inorganic polymer is selected from crosslinked and non-crosslinked polymers.

The organic or inorganic polymer may be a homo- or copolymer having thermoplastic and/or elastomeric properties.

The inorganic polymers may be polyorganosiloxanes.

The organic polymers may be polyurethanes or polyolefins.

The polyolefins can be selected from ethylene and propylene polymers. As examples of ethylene polymers, mention may be made of linear low-density polyethylene (LLDPE), low-density polyethylene (LDPE), medium-density polyethylene (MDPE), high-density polyethylene (HDPE), ethylene-vinyl acetate (EVA) copolymers, copolymers of ethylene and of butyl acrylate (EBA), of methyl acrylate (EMA), or of 2-hexylethyl acrylate (2HEA), copolymers of ethylene and of alpha-olefins, such as for example polyethylene-octenes (PEOs), copolymers of ethylene and of propylene (EPRs), terpolymers of ethylene and of propylene (EPTs), such as for example ethylene propylene diene monomer (EPDM) terpolymers, or a mixture thereof.

The polymer of the polymer sheath is preferably an organic polymer, particularly preferably an olefin polymer, more particularly preferably an ethylene polymer, and even more particularly preferably an ethylene-vinyl acetate copolymer, a linear low-density polyethylene, or a mixture thereof.

The polymer sheath may additionally comprise a hydrated flame-retardant mineral filler. This hydrated flame-retardant mineral filler acts mainly by the physical route by decomposing endothermically (e.g., release of water), which has the consequence of lowering the temperature of the sheath and of limiting the propagation of flames along the cable. The term “flame retardant properties” is used in particular.

The hydrated flame-retardant mineral filler can be a metal hydroxide such as magnesium hydroxide or aluminum trihydroxide.

The polymer sheath may additionally comprise an inert filler, especially selected from talc, micas, dehydrated clays and a mixture thereof.

Step i0)

The method can additionally comprise, before step i), a step i0) of manufacturing the cable comprising at least said elongate electrically conductive element and at least said nonwoven fibrous material impregnated with the geopolymer composition surrounding said elongate electrically conductive element.

Step i0) is preferably carried out at ambient temperature (18-25° C. approximately).

Step i0) may in particular comprise the following substeps:

a) preparing a geopolymer composition,

b) applying a nonwoven fibrous material around a cable comprising at least one elongate electrically conductive element, and

c) impregnating the cable/nonwoven fibrous material assembly with said geopolymer composition.

Substep a)

Substep a) is generally carried out at a high pH, in particular ranging from 10 to 13.

Substep a) preferably comprises the following substeps:

a1) preparing an aqueous solution of the first alkali metal silicate, and

a2) mixing the first aluminosilicate in powder form with the aqueous solution of alkali metal silicate prepared in preceding substep a1).

The aqueous solution of the first alkali metal silicate can be prepared by mixing silicon dioxide SiO₂ or an alkali metal silicate with a base MOH in which M is K or Na.

Silicon dioxide SiO₂ can be selected from silica fume (i.e. fumed silica), quartz, and mixtures thereof.

Substep a1) can be carried out by dissolving the alkaline base in water, resulting in a release of heat (exothermic reaction), and then adding the silica (or the alkali metal silicate). The heat released then accelerates the dissolution of the silica (or of the alkali metal silicate) during substep a1) and of the first aluminosilicate during substep a2).

When the second aluminosilicate and/or the second alkali metal silicate as defined in the invention are present, substep a) of preparing the geopolymer composition may comprise mixing said first aluminosilicate and possibly said second aluminosilicate with said first alkali metal silicate and possibly said second alkali metal silicate, water and optionally the alkaline base.

Substep a) preferably comprises mixing the first and second metakaolins with the first alkali metal silicate and possibly the second alkali metal silicate, water, and optionally an alkaline base.

The first and second metakaolins and the first and second alkali metal silicates are as defined in the invention.

According to a preferred embodiment, substep a) comprises the following substeps:

a1′) mixing the first and second alkali metal silicates, in particular with stirring,

a2′) optionally adding an alkaline base, in particular while maintaining the stirring, and

a3′) adding the first and second metakaolins, in particular while maintaining the stirring.

At the end of substep a), or of substep a2) or a3′), a fluid and homogeneous solution is preferentially obtained.

At the end of substep a), the geopolymer composition may comprise from 35% to 80% by weight approximately, and particularly preferably from 40% to 70% by weight approximately, of solids (alkali metal silicate(s), aluminosilicate(s) and alkaline base), relative to the total weight of said geopolymer composition.

Such a mass ratio makes it possible to have a geopolymer composition that is fluid enough to allow handling thereof, and the solidification kinetics of which are slow enough to allow the formation of a composite cable layer as defined hereinafter.

The solids/water mass ratio in said geopolymer composition can enable determination of the solidification kinetics of said geopolymer composition.

Substep a) is preferably carried out at ambient temperature (18-25° C. approximately).

Substep b)

Substep b) enables the application of the nonwoven material around the elongate electrically conductive element, in particular for forming a cable comprising at least one elongate electrically conductive element and a nonwoven fibrous material surrounding said elongate electrically conductive element.

The nonwoven fibrous material is preferably in the form of a strip or a tape. This thus makes it possible to facilitate substep b).

The nonwoven fibrous material can be applied either directly around one or more elongate conductive elements, or around an inner layer of said cable which is itself around one or more elongate conductive elements.

At the end of substep b), a cable/nonwoven fibrous material assembly is obtained.

When the nonwoven fibrous material is a tape, application substep b) may be carried out by wrapping the tape around the cable.

The wrapping may be longitudinal (i.e. along the longitudinal axis of the cable or, in other words, in the length direction of the cable) or helical, and preferably longitudinal. Longitudinal wrapping makes it possible to reduce the production cost of the cable.

The longitudinal wrapping can also be carried out with overlap zones, the overlap zone(s) representing from 10% to 20% approximately.

Substep b) can be carried out manually or in an automated fashion, and preferably in an automated fashion.

Substep b) can be implemented by passing the nonwoven fibrous material into a constricting device or a forming device (also denoted by the terms “trumpet” or “nonwoven fibrous material former”). The cable comprising at least one elongate electrically conductive element also passes into the constricting device during substep b). This device is a mechanical device that continuously wraps the tape around the elongate electrically conductive element. This thus makes it possible to facilitate the longitudinal wrapping of the tape around the cable.

Substep b) is preferably carried out at ambient temperature (18-25° C. approximately).

Substep c)

Substep c) consists in impregnating the cable/nonwoven fibrous material assembly.

Substep c) can be carried out manually or in an automated fashion, and preferably in an automated fashion.

Substep c) is preferably carried out by dip coating.

Substep c) can for example be carried out using an impregnation bath or tank which comprises the geopolymer composition and into which is passed the cable comprising at least one elongate electrically conductive element and a nonwoven fibrous material surrounding said elongate electrically conductive element.

The impregnation bath or tank is preferably configured to allow passage of the cable of substep b) through said impregnation bath.

The geopolymer composition thus obtained during substep a) is then placed in said impregnation bath to enable substep c).

The impregnation bath or tank is preferably supplied with the geopolymer composition, in particular using means such as a pump. This thus makes it possible to continuously supply said bath or tank with geopolymer composition.

In a preferred embodiment of the invention, impregnation substep c) is carried out at a temperature ranging from 15° C. to 40° C. approximately, and particularly preferably from 20° C. to 30° C. approximately.

The assembly of cable/nonwoven fibrous material impregnated with the geopolymer composition is indirectly used in step i) as defined hereinabove.

For this, the plastic tube is preferably connected to the impregnation bath or tank, for example with mechanical means. Thus, the impregnated cable passes into said plastic tube as soon as it leaves the impregnation bath. This thus makes it possible to maintain the nonwoven fibrous material around the elongate electrically conductive element and/or to maintain the geopolymer composition on the circumference of the cable.

Step i) preferably employs an extension tube directly connected to the impregnation bath. The cable therefore leaves the impregnation bath to pass into the plastic tube via this extension tube.

Preferably, the tube is maintained in place in the extruder head by means of two plastic rings.

The Resulting Cable

The Composite Layer

The composite layer is preferably a fire-resistant and/or fire-retardant layer.

The composite layer preferably has a thickness ranging from 0.2 to 3 mm approximately, and particularly preferably ranging from 0.5 to 1 mm approximately.

When the thickness of the composite layer is less than 0.2 mm, the thermal protection of the cable obtained according to the method of the invention is not sufficient.

The composite layer of the invention is preferably a tape-wound layer (i.e. in the form of a tape or a strip).

The composite layer preferably has a substantially constant thickness and in particular constitutes a continuous protective envelope.

The composite layer may in particular comprise 2 to 3 superposed tapes.

The composite layer of the invention is preferably nonporous.

The composite layer is preferably an inner layer of said cable.

According to the invention, the term “inner layer” is understood to mean a layer which does not constitute the outermost layer of the cable.

The composite layer preferably comprises at least one geopolymer material and the nonwoven fibrous material as defined in the invention.

The Geopolymer Material

In the present invention, the geopolymer material is obtained from a geopolymer composition as defined in the invention, preferably by curing, geopolymerization and/or polycondensation of said geopolymer composition.

In particular, the geopolymer composition as defined in the invention is capable of forming said geopolymer material. The ingredients of the geopolymer composition may therefore undergo polycondensation to form said geopolymer material. The curing is effected by internal reaction of polycondensation type. The curing is not, for example, the result of simple drying, as is generally the case for binders based on alkali metal silicates.

Specifically, the geopolymer materials result from a mineral polycondensation reaction by alkaline activation, referred to as geosynthesis, as opposed to the traditional hydraulic binders in which the curing is the result of a hydration of calcium aluminates and calcium silicates.

In the present invention, the expression “geopolymer material” means a solid material comprising silicon (Si), aluminum (Al), oxygen (O), and at least one element selected from potassium (K), sodium (Na), lithium (Li), cesium (Cs), and calcium (Ca), and preferably selected from potassium (K) and sodium (Na).

The geopolymer material may be an aluminosilicate geopolymer material.

The aluminosilicate geopolymer material may be selected from the poly(sialates) corresponding to formula (I) Mₙ(—Si—O—Al—O—)ₙ [(M)-PS] and having an Si/Al molar ratio equal to 1, the poly(sialate-siloxos) corresponding to formula (II) Mₙ(—Si—O—Al—O—Si—O—)ₙ [(M)-PPS] and having an Si/Al molar ratio equal to 2, the poly(sialate-disiloxos) corresponding to formula (III) Mₙ(—Si—O—Al—O—Si—O—Si—O)ₙ [(M)-PSDS] and having an Si/Al molar ratio equal to 3, and other poly(sialates) with Si/Al ratio >3, the aforementioned poly(sialates) comprising an alkali metal cation M selected from K, Na, Li, Cs and a mixture thereof, and n denoting the degree of polymerization.

In one embodiment, the geopolymer material represents from 5% to 98% by weight approximately, preferably from 55% to 95% by weight approximately, and more preferably from 65% to 90% by weight approximately, relative to the total weight of the composite layer.

The Cable

Advantageously, the cable obtained by a method according to the invention satisfies at least one of the standards for reaction or non-propagation in a fire, selected from the standards EN 60332-1, EN 60332-3, and EN 50399 (2012/02+A1 2016); and preferably the standard EN 50399 (2012/02+A1 2016), in particular the classification criteria B2ca, s1a, d0, a1 of said standard, and optionally the standards EN 60332-1 and EN 60332-3.

According to one embodiment of the invention, the cable is a power and/or telecommunications cable, and preferably an electrical cable.

When the cable comprises a plurality of elongate electrically conductive elements, then the composite layer may surround the plurality of elongate electrically conductive elements of the cable.

The cable may comprise a single composite layer as defined in the invention or a plurality of composite layers as defined in the invention.

When the cable comprises a plurality of composite layers, the method may further comprise the repetition of steps a) to c), as many times as there are composite layers to be applied.

Preferably, the cable comprises a single composite layer, and more particularly preferably a single inner composite layer.

According to one embodiment of the invention, the cable obtained according to the method of the invention additionally comprises one or more layers interposed between the elongate electrically conductive element and the composite layer as defined in the invention.

These layers may comprise one or more polymer layers such as electrically insulating polymer layers and/or one or more metal layers such as metal layers containing one or more apertures.

In this case, the method additionally comprises, before step b) or before step a), one or more steps of applying one or more of the abovementioned layers around the elongate electrically conductive element, around the set of the elongate electrically conductive elements, or around each of the elongate electrically conductive elements, depending on the type of cable desired.

The metal layers containing one or more apertures are typically layers used in radiating cables well known to those skilled in the art.

According to a preferred embodiment of the invention, the cable comprises:
a plurality of electrically conductive elements, each of said electrically conductive elements being surrounded by a polymer layer, especially electrically insulating polymer layer, to form a plurality of insulated electrically conductive elements,
a composite layer as defined in the invention surrounding said plurality of insulated electrically conductive elements, and
a polymer sheath as defined in the invention surrounding said composite layer.

Continuous Method

The method according to the invention is preferably a continuous method. In other words, at least steps i) and ii), and preferably at least steps i0), i) and ii), are carried out continuously.

In the invention, the expression “continuous method” means that the method is carried out on a single production line, and/or without steps of resting, collection, or recovery. In other words, in the method according to the invention, there are no intermediate steps of resting between the distribution of the nonwoven fibrous material or at least the passage, into the plastic tube, of the cable comprising at least said elongate electrically conductive element and at least said nonwoven fibrous material surrounding said elongate electrically conductive element, and the recovery/obtaining of the final cable at the end of step ii). More particularly, steps i) and ii), or steps i0), i) and ii), are simultaneous, i.e. steps i) and ii), or steps i0), i) and ii), are implemented at the same time.

According to this embodiment, the nonwoven fibrous material may be placed on a distributor such as an unwinder or reel, and said material may be distributed or unwound continuously to implement at least steps i0), i) and ii).

Preferably, substep b) is implemented by passing the nonwoven fibrous material in the form of a tape into the constricting or forming device through which a cable comprising at least one elongate electrically conductive element runs, and then the cable thus obtained passes into the impregnation bath or tank comprising the geopolymer composition according to substep c), and then the cable thus impregnated exits the impregnation tank and enters the plastic tube according to step i), a portion of said tube being inserted into the extruder head. Lastly the cable confined within said tube is brought into the die of the extruder head so as to enable the extrusion of the polymer sheath around the cable according to step ii).

The plastic tube is preferably connected to the impregnation bath or tank, for example with mechanical means.

During substep b), the distributor delivers the nonwoven fibrous material at a speed V (in km/min).

The speed V is preferably identical to the running speed of the cable.

Preferably, substep c) is implemented by passing the cable comprising said elongate electrically conductive element and said nonwoven fibrous material surrounding said elongate electrically conductive element into an impregnation bath or tank supplied with the geopolymer composition at a flow rate D (in kg/min). The flow rate D can range from 0.5 kg/min to 36 kg/min approximately or from 36 kg/min to 300 kg/min approximately, and preferably from 0.5 kg/min to 25 kg/min approximately.

The running speed of the cable in substep c) and steps i) and ii) ranges from 10 m/min to 600 m/min approximately, preferably ranges from 20 m/min to 280 m/min approximately, and more preferably from 50 m/min to 200 m/min approximately, and particularly preferably from 50 m/min to 150 m/min approximately.

The method according to the invention is rapid, simple and advantageous from an economic point of view. It makes it possible to manufacture, in few steps, a cable exhibiting good mechanical properties, especially in terms of flexibility and durability, while guaranteeing good fire resistance performance.

### BRIEF DESCRIPTION OF THE DRAWINGS

The appended drawings illustrate the invention:

FIG. 1 represents a schematic view of an electrical cable as obtained by the method according to the invention.

FIG. 2 represents a schematic view of the method according to the invention.

FIG. 3 represents several 3D views of the arrangement of the various parts employed in the method of the invention.

FIG. 4 shows a cross section of part of the extruder during the method of the invention.

For the sake of clarity, only the elements essential for understanding the invention have been represented schematically in these figures, and they are not shown to scale.

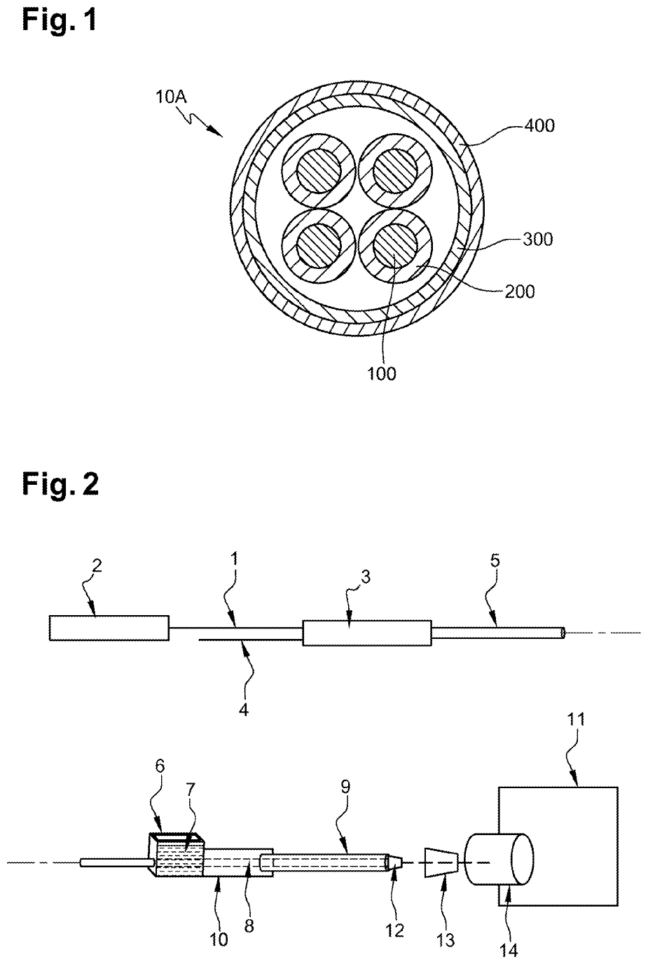

The electrical cable 10A, shown in FIG. 1, corresponds to a fire-resistant electrical cable of K25 or RZ1K type.

This electrical cable 10A comprises four elongate electrically conductive elements 100, each being insulated with an electrically insulating layer 200, and, successively and coaxially around these four insulated elongate electrically conductive elements (100, 200), a composite layer 300 as defined in the invention surrounding the four insulated elongate electrically conductive elements (100, 200), and an outer sheath 400 of HFFR type surrounding the composite layer 300 as defined in the invention.

FIG. 2 illustrates a schematic view of the method according to the invention implemented continuously. In particular, a nonwoven fibrous material 1 in the form of a tape is placed on a winder 2, unwound and fed to a constricting device 3 through which a cable comprising at least one elongate electrically conductive element 4 (bare cable 4) runs, in order to enable the longitudinal wrapping of the tape 1 around the cable 4. Then, the cable obtained and comprising the elongate electrically conductive element and said nonwoven fibrous material surrounding said elongate electrically conductive element 5 pass into an impregnation bath 6 comprising a geopolymer composition 7, so as to allow impregnation of the nonwoven fibrous material 1 by said geopolymer composition 7. The impregnated cable 8 obtained then passes into the plastic tube 9 (e.g. PEEK tube) by means of an extension tube 10 directly connected to the impregnation bath 6, in order to allow the confinement of said cable when it enters the extruder head 11 [step i)]. The plastic tube 9 is connected at its end to a plastic insert 12 (e.g. PEEK insert) configured to adapt to the punch 13 of the extruder head 11. The cable 8 confined in the plastic tube 9 is thus brought into the die 14 of the extruder head 11 via the punch 13, in order to enable the extrusion of the polymer sheath around the cable while preventing any contact of the geopolymer composition with the punch 13 and the metal tools of the extruder head [step ii)].

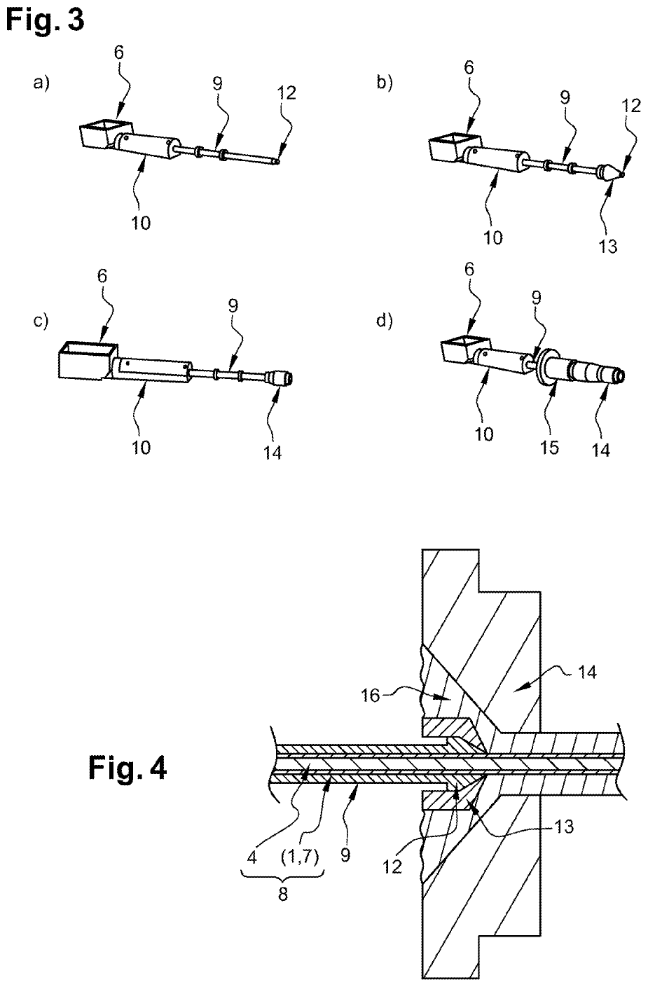

FIG. 3 shows several 3D views of the arrangement of the various parts employed in the method of the invention. In particular, FIG. 3a shows the impregnation tank 6, the extension tube 10, the plastic tube 9, and the plastic insert 12. FIG. 3b shows more specifically the punch 13 and the plastic insert 12 configured to adapt to said punch 13. FIG. 3c shows more specifically the die 14. FIG. 3d shows more particularly a distributor 15 which makes it possible to distribute the molten polymer material used to form the polymer sheath, the material being located between the punch and the die at the time of extrusion.

FIG. 4 shows a cross-sectional view of part of the extruder and shows the arrangement of the various parts during the extrusion of the sheath when the method of the invention is implemented. In particular, FIG. 4 shows an impregnated cable 8 comprising an elongate electrically conductive element 4, and the composite layer (1, 7) obtained from a nonwoven fibrous material 1 impregnated with a geopolymer composition 7 surrounding said elongate electrically conductive element 4. The composite layer (1, 7) is surrounded by the plastic tube 9, and the plastic tube 9 (e.g. PEEK tube) is connected at its end to a plastic insert 12 (e.g. PEEK insert) configured to adapt to the punch 13 of the extruder head. The impregnated cable 8 confined in the plastic tube 9 is thus brought into the die 14 of the extruder head via the punch 13, in order to enable the extrusion of the material 16 of the polymer sheath around the cable while preventing any contact of the geopolymer composition 7 with the punch 13 and the metal tools of the extruder head [step ii)].

The following examples illustrate the present invention. They do not serve to limit the overall scope of the invention as presented in the claims.

### EXAMPLES

The starting materials used in the examples are listed below:
approximately 50% by weight aqueous solution of a first sodium silicate of “waterglass” type, Simalco, sodium silicate of SiO₂/Na₂O molar ratio of about 2.0,
approximately 38% by weight aqueous solution of a second sodium silicate of “waterglass” type, Simalco, sodium silicate of SiO₂/Na₂O molar ratio of about 3.4,
first metakaolin, PoleStar® 450, Imerys, of Al₂O₃/SiO₂ molar ratio of 41/55 (i.e. about 0.745), kaolin calcined at a temperature of about 700° C.,
second metakaolin, PoleStar® 200R, Imerys, of Al₂O₃/SiO₂ molar ratio of 41/55 (i.e. about 0.745), kaolin calcined at a temperature of about 1000° C., and
nonwoven polyester material, GT320, GECA TAPES.

Unless stated otherwise, all of these starting materials were used as received from the manufacturers.

### Example 1: Preparation of a Fire-Retardant Cable by a Method According to the Invention

A geopolymer composition was prepared as follows: an aqueous solution of alkali metal silicates was prepared by mixing 40 g of a 50% by weight aqueous solution of a first sodium silicate and 40 g of a 38% by weight aqueous solution of a second sodium silicate. Then, 10 g of a first metakaolin and 10 g of a second metakaolin were mixed with the aqueous solution of alkali metal silicates. Said geopolymer composition comprises about 55.2% by weight of solids, relative to the total weight of said geopolymer composition.

The geopolymer composition thus obtained is placed in an impregnation bath configured to allow the passage of the cable within said impregnation bath.

In this example, a low-voltage cable comprising five copper conductors of cross section 1.5 mm², each of the conductors being surrounded with an electrically insulating layer based on XLPE, is manufactured beforehand.

A nonwoven fibrous polyester material in the form of a tape is placed on a winder, unwound at a speed of about 100 m/min and brought into a constricting device through which said low-voltage cable runs, in order to enable the longitudinal wrapping of the tape around the cable.

At the end of the step of applying the tape around the cable, said cable is brought to an impregnation bath comprising said geopolymer composition at a speed of about 100 m/min.

Then, the cable thus impregnated passes into a PEEK tube comprising at one end a conical-shaped PEEK insert, said tube being partially inserted into an extruder head equipped with a die and a conical-shaped punch.

When the cable reaches the PEEK insert, the cable is then covered by extrusion at a temperature of 198° C. with a polymer sheath based on an HFFR mixture produced by NEXANS and comprising polyethylene and flame-retardant fillers.

The composite layer thus formed has a thickness of 0.5 mm, and said sheath thus formed has a thickness of about 2 mm.

A cable according to the invention was thus obtained. The flame performance of the cable is determined according to standard EN50399. 15 sections of cable positioned on a vertical ladder are exposed to a flame with a power of 20 kW for 20 min.

The results are reported in table 1 below:

TABLE 1

| | | Class |
|---|---|---|
| | | according to |
| Performance parameters | Values | EN50399 |
| pHRR (kW) | 13.8 | B2 |
| Time at peak HRR (s) | 912 | |
| THR (MJ) | 5.2 | |
| FIGRA (w/s) | 23.6 | |
| Flame propagation (m) | 0.56 | |
| Flaming droplets | None | d0 |
| SPR (m²/s) | 0.03 | s1 |
| Time at peak SPR (s) | 876 | |
| TSP (m²) | 28.12 | |

In this table, the acronym HRR corresponds to the expression “Heat Release Rate” providing information on the heat flow; the acronym THR corresponds to the expression “Total Heat Release”, providing information on the amount of heat released during combustion; the acronym FIGRA corresponds to the expression “FIre GRowth rAte”, providing information on the rate of growth of the fire or the acceleration in the production of energy; the acronym SPR corresponds to the expression “Smoke Production Rate”, providing information on the rate of production of smoke, and the acronym TSP corresponds to the expression “Total Smoke Production”, providing information on the total amount of smoke produced.

These results demonstrate that the cable according to the invention exhibits maximum fire protection properties with respect to the requirements of European standard EN50399.

1. A method for manufacturing a cable having at least one elongate electrically conductive element, at least one composite layer surrounding said elongate electrically conductive element, said composite layer comprising a nonwoven fibrous material impregnated with a geopolymer material, and at least one polymer sheath surrounding said composite layer, said method the steps of:
i) passing a cable comprising at least one elongate electrically conductive element, and at least one nonwoven fibrous material impregnated with a geopolymer composition surrounding said elongate electrically conductive element, into a plastic tube, and
ii) extruding a polymer sheath using an extruder comprising at least one extruder head equipped with a die and a punch,
wherein a portion of said plastic tube is inserted into the extruder head and is configured to prevent contact between the geopolymer composition and the punch of the extruder head.

2. The method as claimed in claim 1, wherein the plastic tube comprises a polymer material selected from the polyaryletherketones.

3. The method as claimed in claim 1, wherein the plastic tube is configured such that the distance “d” between the outer surface of the nonwoven fibrous material and the inner surface of said tube is at most 1 mm.

4. The method as claimed in claim 1, wherein the portion of the tube that is inserted into the extruder head comprises an end which is connected to a plastic insert configured to adapt to the punch of the extruder head.

5. The method as claimed in claim 1, wherein the nonwoven fibrous material is selected from cellulosic materials, materials based on synthetic organic polymers, glass fibers and a mixture thereof.

6. The method as claimed in claim 1, wherein the geopolymer composition is an aluminosilicate geopolymer composition.

7. The method as claimed in claim 1, wherein step ii) is carried out at a temperature ranging from 140° C. to 225° C.

8. The method as claimed in claim 1, wherein said method additionally comprises, before step i), a step i0) of manufacturing the cable comprising at least said elongate electrically conductive element and at least said nonwoven fibrous material impregnated with the geopolymer composition surrounding said elongate electrically conductive element, said step i0) comprising the following substeps:
a) preparing a geopolymer composition,
b) applying a nonwoven fibrous material around a cable comprising at least one elongate electrically conductive element, said nonwoven fibrous material being in the form of a tape, and
c) impregnating the cable/nonwoven fibrous material assembly with said geopolymer composition.

9. The method as claimed in claim 8, wherein substep b) is implemented by passing the tape into a constricting device.

10. The method as claimed in claim 8, wherein substep c) is carried out by dip coating, using an impregnation bath which comprises the geopolymer composition and into which is passed the cable comprising at least one elongate electrically conductive element and a nonwoven fibrous material surrounding said elongate electrically conductive element.

11. The method as claimed in claim 8, wherein said method is a continuous method.

12. The method as claimed in claim 11, wherein the nonwoven fibrous material is disposed on a distributor, and said material is continuously distributed for implementing at least steps i0), i) and ii).

13. The method as claimed in claim 11, wherein substep b) is implemented by passing the nonwoven fibrous material into a constricting device through which a cable comprising at least one elongate electrically conductive element runs, and then the cable thus obtained passes into an impregnation bath comprising the geopolymer composition according to substep c), and then the cable thus impregnated exits the impregnation bath and enters the plastic tube according to step i), a portion of said tube being inserted into the extruder head, and lastly the cable confined within said tube is brought into the die of the extruder head so as to enable the extrusion of the polymer sheath around the cable according to step ii).

14. The method as claimed in claim 11, wherein the running speed of the cable in substep c) and steps i) and ii) ranges from 10 m/min to 600 m/min.
